(19) United States
(12) Patent Application Publication
(10) Pub. No.: US 2012/0240756 A1
(43) Pub. Date: Sep. 27, 2012

(54) Trauma Reducing Pack

(75) Inventors: YVES BADER, Crozet (FR); Nicolas Pont, T. Julien En Genevois (FR); Dominique Burr, Wittenheim (FR)

(73) Assignee: E. I. DU PONT DE NEMOURS AND COMPANY, Wilmington, DE (US)

(21) Appl. No.: 13/235,637

(22) Filed: Sep. 19, 2011

Related U.S. Application Data
(60) Provisional application No. 61/425,327, filed on Dec. 21, 2010.

(51) Int. Cl. F41H 5/04; B32B 37/14

(52) U.S. Cl. 89/36.02; 156/308.2; 89/915

(57) ABSTRACT

The present invention provides for a trauma reducing pack, comprising at least one first layer of textile fabric consisting of yarns with fibers having a tensile strength of at least 900 MPa having an inner and outer surface, at least one second layer of textile fabric consisting of yarns with fibers having a tensile strength of at least 900 MPa having an inner and outer surface, an assembly of three to ten layers of a polyolefinic textile fabric, and a polyolefinic adhesive having a melting point of from 90° C. to 170° C., wherein the inner surface of the at least one first and the at least one second layer of textile fabric consisting of yarns are in contact with the assembly, and wherein the at least one first layer, the at least one second layer and the assembly are bonded together by means of the polyolefinic adhesive.

### 1. FIELD OF THE INVENTION

The present invention relates to trauma reducing laminates.

### 2. BACKGROUND OF THE INVENTION

When a high velocity projectile, such as for example a bullet from a handgun, impacts on the “pack” of a ballistic protection equipment, the projectile does not generally pass through the protection equipment.

Instead, the projectile transmits its kinetic energy to the pack and thus heavily deforms the back face of the pack towards the wearer of the ballistic protection equipment (PPE) which was impacted.

This deformation, also known also as “backface indentation” or “backface deformation”, may result in injuries that will either disable or even kill the wearer of the PPE, depending on the amount of energy that can be dissipated by the PPE and the amount of energy that is transmitted to the wearer.

The more energy the PPE is able to dissipate, the less severe the resulting backface indentation will be.

In test such as NIJ 010106 of July 2007: “Ballistic Resistance of Personal Body Armor”, the depth of the backface indentation on a clay box upon impact of a projectile is used as a means to quantify the severity of the blow, or trauma, to which a hypothetical wearer would be subjected.

In a continuous effort to manufacture PPEs that diminish the blow suffered by a person upon projectile impact, several technologies featuring a trauma-reducing “pack” have been suggested in the literature.

GB2232063 by Lee describes a trauma reducing protective shield comprising two parallel layers of textile material, sandwiching a plurality of PP fibers extending perpendicular to the plane of the two parallel layers. Upon impact, the perpendicular fibers, which can be optionally impregnated with resin, become crushed and absorb and dissipate the kinetic energy of the projectile, which in turn lessens the intensity of trauma.

WO2006136323 by Boettger et al. discloses a trauma reducing pack comprising at least one panel of plastic material and at least one textile fabric layer affixed to the panel and consisting of yarns with fibers having a tensile strength of at least 900 MPa as measured according to ASTM D7269, wherein the plastic material is a self-reinforced thermoplastic material, such as for example PP tapes, these being in close contact to one another and bonded to one another at elevated temperature. These structures are able to provide a minor reduction in backface indentation and additionally suffer from flammability issues.

WO2007021611 by Morin et al. discloses structures comprising high-modulus polyolefin fibers, in particular PP tape fibers, sandwiched between aramid fibers using an adhesive that are suitable in marine, automotive and electronic applications. However, these structures are designed to be stiff and hard, which is an undesirable property in ballistics.

Still, there is a strong felt need for lighter, better performing trauma pack laminates or structures that provide higher protection from blunt trauma and that increase survival rates while being less flammable than the trauma packs known in the art and comfortable to wear.

### SUMMARY OF THE INVENTION

The present invention provides for a trauma reducing pack, comprising at least one first layer of textile fabric consisting of yarns with fibers having a tensile strength of at least 900 MPa as measured according to ASTM D7269 having an inner and outer surface, at least one second layer of textile fabric consisting of yarns with fibers having a tensile strength of at least 900 MPa as measured according to ASTM D7269 having an inner and outer surface, an assembly of three to ten layers of a polyolefinic textile fabric, and a polyolefinic adhesive having a melting point of from 90° C. to 170° C., wherein the inner surface of the at least one first and the at least one second layer of textile fabric consisting of yarns are in contact with the assembly, and wherein the at least one first layer, the at least one second layer and the assembly are bonded together by means of the polyolefinic adhesive.

### BRIEF DESCRIPTION OF THE DRAWING(S)

FIG. 1 is a schematic of an impactor test rig.

### DETAILED DESCRIPTION

The present invention provides for a trauma reducing pack, comprising at least one first layer of textile fabric consisting of yarns with fibers having a tensile strength of at least 900 MPa as measured according to ASTM D7269 having an inner and outer surface, at least one second layer of textile fabric consisting of yarns with fibers having a tensile strength of at least 900 MPa as measured according to ASTM D7269 having an inner and outer surface, an assembly of three to ten layers of a polyolefinic textile fabric, and a polyolefinic adhesive having a melting point of from 90° C. to 170° C., wherein the inner surface of the at least one first and the at least one second layer of textile fabric consisting of yarns are in contact with the assembly, and wherein the at least one first layer, the at least one second layer and the assembly are bonded together by means of the polyolefinic adhesive.

Preferably, the present invention provides for a trauma reducing pack, comprising a first layer of textile fabric consisting of yarns with fibers having a tensile strength of at least 900 MPa as measured according to ASTM D7269 having an inner and outer surface, a second layer of textile fabric consisting of yarns with fibers having a tensile strength of at least 900 MPa as measured according to ASTM D7269 having an inner and outer surface, an assembly of three to ten layers of a polyolefinic textile fabric, and a polyolefinic adhesive having a melting point of from 90° C. to 170° C., wherein the inner surface of the first and the second layer of textile fabric consisting of yarns are in contact with the assembly, and wherein the first layer, the second layer and the assembly are bonded together by means of the polyolefinic adhesive.

In another embodiment the present invention provides for a trauma reducing pack, consisting of a first layer of textile fabric consisting of yarns with fibers having a tensile strength of at least 900 MPa as measured according to ASTM D7269 having an inner and outer surface, a second layer of textile fabric consisting of yarns with fibers having a tensile strength of at least 900 MPa as measured according to ASTM D7269 having an inner and outer surface, an assembly of three to ten layers of a polyolefinic textile fabric, and a polyolefinic adhesive having a melting point of from 90° C. to 170° C., wherein the inner surface of the first and the second layer of textile fabric consisting of yarns are in contact with the assembly, and wherein the first layer, the second layer and the assembly are bonded together by means of the polyolefinic adhesive.

Trauma reducing packs are a part of most ballistic protection equipment (PPE's) in which a reduction of backface indentation is sought by dissipation of the kinetic energy of an incoming projectile.

The at least one first layer of textile fabric and the at least one second layer of textile fabric of the trauma reducing pack according to the present invention consist of yarns which are interlaced such as to form a textile fabric having a areal density of from 50 g/m² to 2000 g/m², more preferably of from 100 g/m² to 400 g/m² when measured according to ASTM D3776.

The yarns may be preferably interlaced by means of weaving techniques, knitting techniques and/or felting techniques.

More preferably, the yarns may be interlaced by means of weaving techniques and/or knitting techniques, and most preferably by weaving techniques.

Suitable weaving techniques by which the yarn may form a textile fabric are plain weave, basket weave, twill weave, satin weave and/or other complex weaves such as for example unidirectional, quasi unidirectional, multi-axial weaves as described in EP0805332, and three dimensional materials; and/or combinations thereof.

The yarns that may form the textile fabric may be chosen among spun yarns, core-spun yarns, filament yarns, texturized yarns, stretch broken yarns, drawn yarns, tape yarns, and/or combinations thereof.

The fibers useful for the yarns of the textile fabric according to the invention may be chosen among fibers having a tensile strength of at least 900 MPa as measured according to ASTM D7269 when measured according to ASTM D638. Preferably, the tensile strength of the fibers is of from 900 MPa to 4600 MPa, more preferably of from 2600 MPa to 4600 MPa, as measured according to ASTM D7269.

The fibers and their materials useful for the yarns of the textile fabric according to the invention may be chosen from materials having thermal properties of low or no flammability and/or high melting point i.e. a melting point above 180° C. and more preferably of from 190° C. to 300° C.

The fibers and their materials useful for the yarns of the textile fabric according to the invention may be chosen also from materials having high decomposition temperature, i.e. a decomposition temperature of or above 400° C. and more preferably decomposition temperature of from 400° C. to 600° C. in air when tested with a temperature rise of 10° C./minute.

The term “fiber”, as used herein refers to staple fibers as well as continuous filaments.

The fibers useful in the present invention may comprise natural or synthetic materials.

Natural materials for the fibers may be chosen among cellulosic materials such as cotton, linen, ramie, rayon and/or combinations thereof.

Preferably, the fibers comprise a synthetic material. Synthetic materials for the fibers may be chosen among polymers such as for example polyolefins, polyamides, polyamide imides, polyarylene sulfides, polyimides, polysulphones, polybenzobisoxazoles, polybenzimidazoles, polyhydroquinone-diimidazopyridines, polyester, and/or blends thereof.

Preferably, the synthetic material may be chosen among polyolefins, polyamides, polyamide imides, polyarylene sulfides, polyimides, polysulphones, polybenzobisoxazoles, polybenzimidazoles, polyhydroquinone-diimidazopyridines and/or blends thereof.

Most preferably, the synthetic material is a polyamide.

In the case where the synthetic material is a polyolefin, the synthetic material may be chosen among polyethylenes such as ultra high molecular weight polyethylene or polypropylenes such as semi-crystalline polypropylene, with the proviso that the polyolefins of the textile fabric are different from the polyolefins of the polyolefinic textile fabric.

In the case where the synthetic material is a polyamide, the synthetic material may be chosen from aliphatic, semi-aromatic and aromatic polyamides, preferably from aromatic polyamides. Aliphatic polyamides may be chosen among nylons such as Nylon 6, Nylon 66, Nylon 612, Nylon 46, Nylon 10, Nylon 12, Nylon 34, Nylon 8 and/or combinations thereof. Aromatic polyamides may be chosen among meta-aramides, para-aramides such as poly-paraphenylene terephtalamide, and/or combinations thereof and are most preferred because of their excellent heat resistance, low flammability and tensile strength.

The assembly of three to ten layers of a polyolefinic textile fabric of the trauma reducing pack according to the present invention consist of tape yarns which are interlaced such as to from layers of polyolefinic textile fabric which are then combined into the assembly.

The individual layers of polyolefinic textile fabric may have an areal density of from 50 g/m² to 500 g/m², more preferably of from 75 g/m² to 250 g/m² when measured according to ASTM D3776.

The tape yarns of the polyolefinic textile fabric may be preferably interlaced by means of weaving techniques, knitting techniques and/or felting techniques.

More preferably, the tape yarns may be interlaced by means of weaving techniques and/or knitting techniques, and most preferably by weaving techniques such as plain weave, basket weave, twill weave, satin weave and/or other complex weaves such as for example unidirectional, quasi unidirectional, multi-axial weaves as described in EP0805332, and three dimensional materials, and/or combinations thereof.

Most preferably, the polyolefinic textile fabric of the trauma reducing pack according to the present invention consist of tape yarns which are interlaced by plain weave, basket weave or twill weave.

The tape yarns of the polyolefinic textile fabric are preferably tape yarns having a tensile strength of from 100 MPa to 300 MPa when measured according to ASTM D638 and having a tensile modulus of from 3 to 8 GPa when measured according to ASTM D638.

The material of which the tape yarns of the polyolefinic textile fabric are made may be chosen from polyolefins, such as for example polyethylene and/or polypropylene.

The term “polypropylene” interchangeably refers to homopolymers of propylene and copolymers of propylene and olefins having an unsaturated bond at the alpha carbon.

The term “polyethylene” interchangeably refers to homopolymers of ethylene and copolymers of propylene and olefins having an unsaturated bond at the alpha carbon.

Preferably, the material of which the tape yarns are made is chosen from semi-crystalline polyolefins, such as for example semi-crystalline polyolefins having a elongation at break of less than 12%, preferably of from 1% to 12%, more preferably of from 3% to 10%, and most preferably of from 4% to 8%, when measured according to ASTM D648.

The tape yarns may be manufactured in a manner known in the art, such as for example by extrusion of a polyolefinic tape yarn with a highly mono-axially drawn core for strength properties, or as a sheet which is subsequently sliced or slit into tapes.

The drawing of the polyolefinic tape yarn increases the crystallinity of the polyolefin and therefore gives it outstanding mechanical properties and low heat shrinkage.

The suitable polyolefinic adhesive according to the present invention may be chosen from polyolefins, such as for example polyethylenes, ethylene copolymers, propylenes, propylene copolymers, and/or combinations thereof, having a melting point of from 90° C. to 170° C. when measured according to ASTM1238, preferably of from 100° C. to 140° C., and having melt flow viscosity of from 0.2 g/10 min to 2 g/10 min when measured according to ASTM1238 at 190° C. using a weight of 2.16 kg.

Choosing a polyolefinic adhesive having a melting point 90° C. to 170° C. enables the first and second textile fabrics to be consolidated with the assembly of polyolefinic textile fabrics without risking an excessive thermally induced shrinkage of the polyolefinic textile fabrics.

In case the thermally induced shrinkage of the polyolefinic textile fabrics is above 12%, the polyolefinic textile fabric will start warping unless it is fixed within a frame holding it taut, the use of which will considerably complicate the manufacture of the trauma pack.

The polyolefinic adhesive may be grafted.

Suitable grafting agents may be chosen among ethylenically unsaturated organic acids and their esters, half-esters and anhydrides such as for example maleic anhydride, alkyl hydrogen maleate, maleic acid, fumaric acid, alkyl hydrogen fumarate, and/or combinations thereof.

In the case where the polyolefins are grafted, the grafting agent is present of from 0.1 weight percent to 3.5 weight percent, based on the total weight of the polyolefin.

Suitable polyethylenes may be chosen among very low density polyethylenes (VLDPE), linear low density polyethylenes (LLDPE), low density polyethylenes (LDPE), metallocene polyethylenes (mPE), high density polyethylenes (HDPE), ultra high molecular weight polyethylenes (UHMWPE) and/or combinations thereof. Preferably, the polyethylene is a metallocene polyethylene, such as for example an ethylene hex-1-ene copolymer.

Suitable ethylene copolymers may be chosen among ethylene vinyl acetate, ethylene (meth)acrylate copolymers, ethylene (meth)acrylic acid copolymers and their corresponding ionomers, ethylene vinyl alcohol, and/or combinations thereof.

The polyolefinic adhesive may be suitably applied to the assembly of polyolefinic textile fabric in various ways, such as for example by placing the adhesive in between the layers of polyolefinic fabric and/or on both sides of the assembly.

Preferably, the polyolefinic adhesive is applied in the form of a sheet, powder, granule, melt, and/or combinations thereof and more preferably in the form of a sheet having an areal density of from 15 g/m² to 50 g/m².

The at least one first layer of textile fabric and the at least one second layer of textile fabric according to the trauma reducing pack of the present invention have an inner surface and an outer surface.

For the purpose of the present invention, textile fabrics are approximated to two-dimensional objects having two sides or surfaces.

The term “inner surface” refers to the surface of the first textile and/or the second textile fabric which is facing the polyolefinic textile fabric of the trauma reducing pack.

The term “outer surface” refers to the surface of the textile fabric that is opposite of the inner surface of the textile fabric.

The trauma reducing pack of the present invention may be assembled by placing the assembly of polyolefinic textile fabric and the polyolefinic adhesive between the inner surface of the at least one first textile fabric and the inner surface of the at least one second textile fabric such that the inner surfaces of the textile fabrics are in contact with the assembly of polyolefinic textile fabric.

Thus, a stack according to the above is formed that may be consolidated by the simultaneous application of heat and pressure, such as for example in a heat press.

The heat applied is preferably such that the stack will heat up to of from 90° C. to 170° C., preferably from 100 to 140° C., in order to melt the polyolefinic adhesive for from 2 minutes to 45 minutes.

The pressure applied is preferably normal to the plane formed by the trauma reducing pack and may be chosen of from 10 bars to 1000 bars for from 2 minutes to 45 minutes.

After from 2 minutes to 45 minutes, the stack is cooled to from 25° C. to 80° C. in order to solidify the polyolefinic adhesive, but the pressure is maintained until the stack reaches of from 25° C. to 80° C. such that the hardened polyolefinic adhesive binds the stack together to form the trauma reducing pack according to the present invention.

The present invention further provides a personal protection equipment (PPE), comprising a trauma reducing pack.

Since the primary function of the trauma reducing pack is not to stop the bullet, but to lessen the depth of the backface indentation, the trauma reducing pack according to the present invention is arranged behind the main ballistic pack of the personal protection equipment which faces an incoming threat.

The present invention also provides several body armor variants comprising a trauma pack according to the invention against blunt attacks by for example stone throws, baton or baseball bat attack, which can be used by police forces. Body armor can be a limb armor such as for example a shin guard, foot guard, arm guards and hand guards; torso armor such as for example a shoulder guard and torso guards; and can also be non-ballistic helmets.

In a body armor, the trauma pack according to the invention may be arranged behind one or more layers of a hard and/or stiff material such as for example glass fiber composites, carbon fiber composites and curable resins.

The present invention is further defined in the following Examples. It should be understood that these Examples are given by way of illustration only.

### EXAMPLES

### Example 1

### Inventive Sample

A textile fabric having a plain weave and an areal weight of 185 g/m², consisting of poly-paraphenylene terephtalamide yarns having a linear density of 1100 dtex and 8.5 ends/cm (warp) and 8.5 ends/cm (weft), commercially available from Saati (Legnano, Italy) under the trademark Kevlar® S802G was cut into pieces of 40 cm by length and 20 cm by width.

A polyolefinic textile fabric having plain weave and an areal weight of 100 g/m² and consisting of polypropylene tape fibers having a thickness of 50 μm, commercially available from Milliken (Spartanburg, S.C.) under the trademark Tegris® was cut into pieces of 40 cm by length and 20 cm by width.

A sheet of metallocene linear low density polyethylene (mLLDPE) adhesive having an areal weight of 46 g/m² and having a thickness of 50 μm, commercially available from Exxon Mobil under the trademark Exceed® 1018CA was cut into pieces of 40 cm by length and 20 cm by width.

A stack was formed by superposing, in this order, a first textile fabric of Kevlar®, a first layer of polyolefinic adhesive, four layers of polyolefinic textile fabric, a second layer of polyolefinic adhesive and a second layer of Kevlar®.

The stack was consolidated in an industrial hydraulic press having heating and cooling capability for 35 minutes at 150° C. and 40 bars and then cooled to etc., to yield a trauma reducing pack having an areal density of 900 g/m².

### Example 2

### Control Sample

The control samples having 40 cm by length and 20 cm by width were cut from sheets of commercially available trauma reducing packs sold under the name LFT AT from Teijin Twaron (Wuppertal, Germany), having an areal density of 500 g/m².

### Blunt Trauma Reduction Test

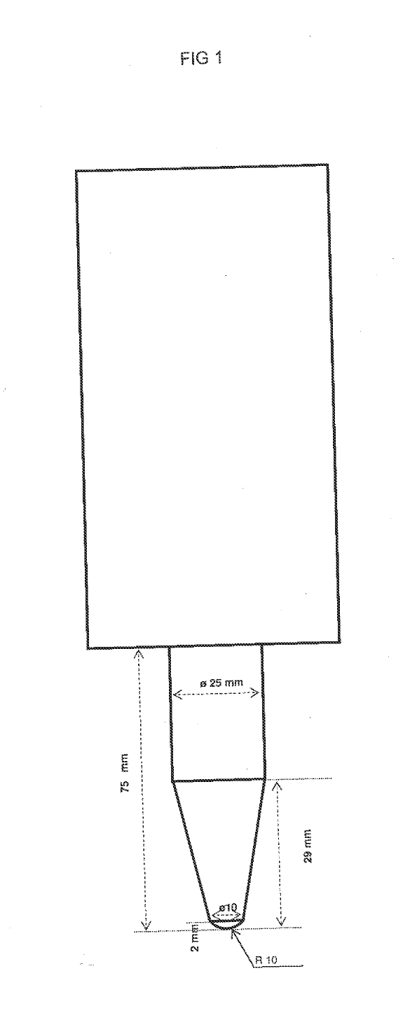

A blunt impactor having a mass of 2.973 kg was dropped from an height of 2.3 m, such as to have an impact energy of 67 J, onto a test sample covering a box of plastilina, commercially available from Caran d'Ache under ref. 0259.051. The shape and dimensions of the impactor are depicted in FIG. 1.

After the impactor hit a sample, the depth of the backface indentation was measured and recorded; the results are shown in Table 1. For each test sample, the test was repeated 2 times.

The inventive sample consisted of a trauma reducing pack according to Example 1.

The comparative sample consisted of two superposed trauma reducing packs according to Example 2, in order to achieve a comparable areal density to the inventive sample of Example 1.

Table 1 shows the depth of the backface indentation in millimeters for each blunt impact separated by commas, as well as the mean backface indentation depth in millimeters, for the both an inventive sample and for two superposed control samples.

TABLE 1

| | | Backface | Backface |
|---|---|---|---|
| | Areal density | indentation | indentation |
| | (g/m²) | (mm) | mean (mm) |
| Inventive sample | 900 | 17.18 | 16.5 ± 2 |
| Control sample | 1000 | 20.22 | 21 ± 2 |
| Naked | 0 | 75.75 | 75 |

### Ballistic Trauma Reduction Test

Test samples were placed behind a ballistic pack consisting of 12 layers of a multi-axial aramid laminate, commercially available from E.I. du Pont de Nemours & Co., (Wilmington, USA) under the trademark Kevlar® XPS307, and a layer of closed-cell foam backing having an areal density of 100 g/m² and a thickness of 3 millimeters in order to form a stack.

The inventive test sample consisted of a trauma reducing pack according to Example 1.

The comparative test sample consisted of two superposed trauma reducing packs according to Example 2, in order to achieve a comparable areal density to the inventive sample of Example 1.

Each stack was fastened to a clay box of Roma No 1 clay, with the ballistic pack facing away from the clay box and then subjected to a ballistic impact of a 0.357 cal. Magnum SPFN bullet traveling at a speed of 436 m/s., shot from a distance of 5 meters.

After the bullet hit the stack, the depth of the backface indentation was measured and recorded; the results are shown in Table 2. For each test sample, the test was repeated 2 times.

Table 2 shows the depth of the backface indentation in millimeters for each ballistic impact separated by commas, as well as the mean backface indentation depth in millimeters, for the both an inventive sample and for two superposed control samples.

TABLE 2

| | | Backface | Backface |
|---|---|---|---|
| | Areal density | indentation | indentation |
| | (g/m²) | (mm) | mean (mm) |
| Inventive sample | 4600 | 29.26 | 27.5 ± 2 |
| Control sample | 4700 | 30.29 | 29.5 ± 2 |
| Naked | 3700 | 37.37 | 37 |

### Flammability Test

A limited flame spread test was conducted according to standard EN ISO 15025 of 2005, Procedure B: “Hemmed Edge Ignition”. By “Low Flammability” we mean that a test sample passes the ISO 15025 ignition test.

The inventive test sample passed all test criteria by showing no flame, no hole, no debris, no after-flame and no afterglow.

The control sample did not pass all test criteria, since it burned to the top and to the edges, and presented melting debris and burning droplets.

What is claimed is:

1. A trauma reducing pack, comprising
a. at least one first layer of textile fabric consisting of yarns with fibers having a tensile strength of at least 900 MPa as measured according to ASTM D7269 having an inner and outer surface,
b. at least one second layer of textile fabric consisting of yarns with fibers having a tensile strength of at least 900 MPa as measured according to ASTM D7269 having an inner and outer surface,
c. an assembly of three to ten layers of a polyolefinic textile fabric, and
d. a polyolefinic adhesive having a melting point of from 90° C. to 170° C.,
wherein the inner surface of the at least one first and the at least one second layer of textile fabric consisting of yarns are in contact with the assembly and wherein the at least one first layer, the at least one second layer and the assembly are bonded together by means of the polyolefinic adhesive.

2. The trauma reducing pack according to claim 1, wherein the layers of the polyolefinic textile fabric of c. comprise a warp and weft system of polypropylene tapes.

3. The trauma reducing pack according to claim 1 or 2, wherein the polyolefinic adhesive d. is a grafted polyolefin.

4. The trauma reducing pack according to claim 1 or 3, wherein the polyolefinic adhesive d. is chosen from polyethylenes, ethylene copolymers, propylenes, propylene copolymers, and/or combinations thereof.

5. The trauma reducing pack according to claims 1 to 4, wherein the at least one first layer of textile fabric and the at least one second layer of textile fabric consist of yarns which are interlaced such as to form a textile fabric having a areal density of from 50 g/m² to 2000 g/m² measured according to ASTM D3776.

6. The trauma reducing pack according to claims 1 to 5, wherein the fibers of the yarns of the textile fabric of a. and b. are chosen among fibers having a tensile strength of from 900 MPa to 4600 MPa as measured according to ASTM D7269.

7. The trauma reducing pack according to claims 1 to 6, wherein the fibers and their materials of the yarns of the textile fabric of a. and b. are chosen from materials having thermal properties of low or no flammability.

8. The trauma reducing pack according to claims 1 to 6, wherein the fibers and their materials of the yarns of the textile fabric of a. and b. are chosen from materials having high melting point of from 190° C. to 300° C.

9. The trauma reducing pack according to claims 1 to 6, wherein the fibers and their materials of the yarns of the textile fabric of a. and b. are chosen from materials having high decomposition temperature of from 400° C. to 600° C. in air when tested with a temperature rise of 10° C./minute.

10. The trauma reducing pack according to claims 1 to 9, wherein the layers of the polyolefinic textile fabric have an areal density of from 50 g/m² to 500 g/m² measured according to ASTM D3776.

11. The trauma reducing pack according to claims 1 to 10, wherein the yarns of the polyolefinic textile fabric are tape yarns having a tensile strength of from 100 MPa to 300 MPa when measured according to ASTM D638 and having a tensile modulus of from 3 to 8 GPa when measured according to ASTM D638.

12. Preparation of the trauma reducing pack according to claims 1 to 11 comprising the steps placing the assembly of the polyolefinic textile fabric and the polyolefinic adhesive between the inner surface of the at least one first textile fabric and the inner surface of the at least one second textile fabric such that the inner surfaces of the textile fabrics are in contact with the assembly of polyolefinic textile fabric and consolidation by the simultaneous application of heat and pressure.

13. A personal protection equipment (PPE) comprising a trauma reducing pack according to claims 1 to 11.

14. A body armor comprising a trauma reducing pack according to claims 1 to 11.
